(19) United States
(12) Patent Application Publication
(10) Pub. No.: US 2009/0129807 A1
(43) Pub. Date: May 21, 2009

(54) Imaging Apparatus Having An Environment Friendly Green Mode

(76) Inventors: Marvin Nicholson, III, Lexington, KY (US); John Thomas Writt, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/942,779

(22) Filed: Nov. 20, 2007

(51) Int. Cl. G03G 15/00

(52) U.S. Cl. 399/85

(57) ABSTRACT

An imaging apparatus includes a print engine for printing an image on a sheet of media. A sheet feed mechanism is configured to feed the sheet of media through the print engine. A controller is communicatively coupled to the sheet feed mechanism and the print engine to operate the sheet feed mechanism and the print engine in a selected one of a plurality of operation modes. The plurality of operation modes include a continuum representing a plurality of traditional printing modes, the continuum being defined in terms of print quality versus mode throughput rate wherein a decrease in print quality corresponds to an increase in mode throughput rate. A Green Mode is located outside the continuum.

### CROSS-REFERENCE TO RELATED APPLICATIONS

None.

### MICROFICHE APPENDIX

None.

### GOVERNMENT RIGHTS IN PATENT

None.

### BACKGROUND OF THE INVENTION

1. Field of the Invention

The present invention relates to imaging, and, more particularly, to an imaging apparatus having an environment friendly “Green Mode” of operation.

2. Description of the Related Art

Imaging apparatuses, such as printers and all-in-one (AIO) machines having printing functionality, typically have three or more traditional printing modes: e.g., Draft Mode, Normal Mode, and Best/Photo Mode. These modes typically make a trade-off between printer throughput and print quality. For example, in comparing the Draft Mode, Normal Mode, and Best/Photo Mode, in that order, the printer throughput decreases as the print quality increases.

An increasing number of people are becoming environmentally aware, and have a stronger desire to reduce personal energy consumption from non-renewable energy sources, commonly referred to as going “green” or reducing one's “carbon footprint”.

### SUMMARY OF THE INVENTION

The present invention provides an imaging apparatus having an environment friendly “Green Mode” of operation.

The terms “first” and “second” preceding an element name, e.g., first print quality, second print quality, etc., are used for identification purposes to distinguish between similar or related elements, results or concepts, and are not intended to necessarily imply order, nor are the terms “first” and “second” intended to preclude the inclusion of additional similar or related elements, results or concepts, unless otherwise indicated.

The invention, in one form thereof, is directed to an imaging apparatus. The imaging apparatus includes a print engine for printing an image on a sheet of media. A sheet feed mechanism is configured to feed the sheet of media through the print engine. A controller is communicatively coupled to the sheet feed mechanism and the print engine to operate the sheet feed mechanism and the print engine in a selected one of a plurality of operation modes. The plurality of operation modes include a continuum representing a plurality of traditional printing modes, the continuum being defined in terms of print quality versus mode throughput rate wherein a decrease in print quality corresponds to an increase in mode throughput rate. A Green Mode is located outside the continuum.

The invention, in another form thereof, is directed to an imaging apparatus. The imaging apparatus includes a print engine for printing an image on a sheet of media. A sheet feed mechanism is configured to feed the sheet of media through the print engine. A controller is communicatively coupled to the sheet feed mechanism and the print engine to operate the sheet feed mechanism and the print engine in a selected one of a plurality of operation modes. The operation modes include a Best Mode having a first print quality and a first mode throughput rate; a Normal Mode having a second print quality lower than the first print quality and a second mode throughput rate higher than the first mode throughput rate; a Draft Mode having a third print quality lower than the second print quality and a third mode throughput rate higher than the second mode throughput rate; and a Green Mode having a fourth print quality lower than the second print quality and a fourth mode throughput rate lower than the third mode throughput rate resulting in an energy consumption less than any of the Best Mode, the Normal Mode and the Draft Mode.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 schematically depicts an imaging apparatus in accordance with an embodiment of the present invention.

FIG. 2 depicts portions of the print engine of the imaging apparatus of FIG. 1.

FIG. 3 is a graph illustrating by example the Green Mode, in relation to a continuum of traditional printing modes.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

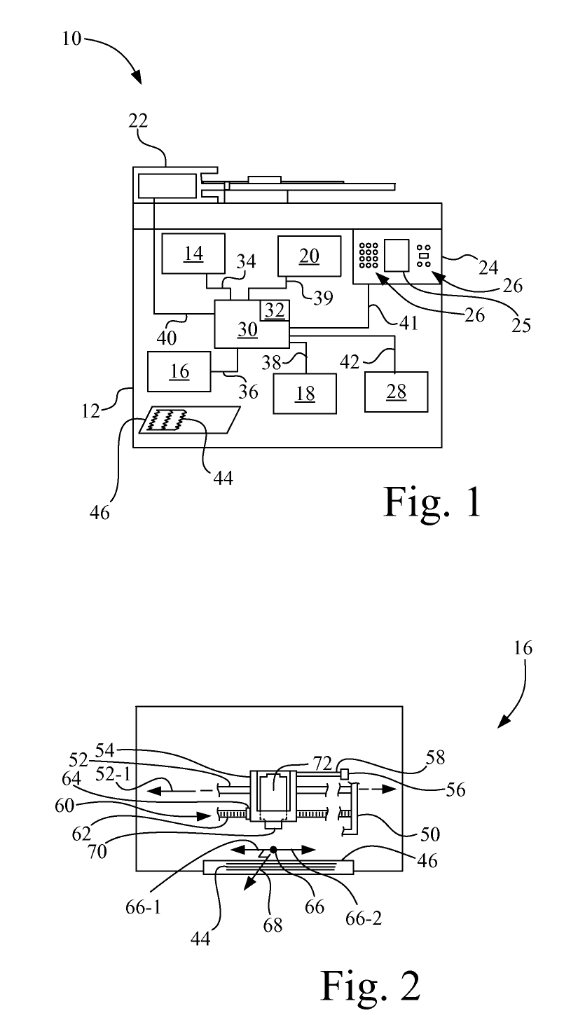

Referring now to the drawings and particularly to FIG. 1, there is shown an imaging apparatus 10 in accordance with an embodiment of the present invention.

Imaging apparatus 10 is an imaging device that produces a printed or scanned output of a patent or latent image. As used herein, an image is a rendering such as may be obtained via an external device, such as for example, a computer, digital camera or scanner, and which may be printed or displayed for viewing by the human eye.

Imaging apparatus 10 may be, for example, an ink jet printer and/or copier, an electrophotographic printer and/or copier, a fax machine, a dedicated scanner, or an all-in-one (AIO) machine that includes a printer, a scanner, and possibly a fax unit, or a stand alone scanner.

In the present embodiment, imaging apparatus 10 is depicted as an AIO machine, and includes a body 12 housing a scanner unit 14, a print engine 16, a sheet feed mechanism 18 for supplying print media to print engine 16 and supporting the print media that has been printed, a fax unit 20, an automatic document feeder (ADF) 22 located adjacent to scanner unit 14, a user interface 24 having a display 25 and control buttons 26 to facilitate user interaction with imaging apparatus 10, a wireless communication unit 28, and a controller 30 for controlling scanner unit 14, print engine 16, sheet feed mechanism 18, fax unit 20, and automatic document feeder 22.

Controller 30 includes a processor unit and associated memory 32, and may be formed as an Application Specific Integrated Circuit (ASIC). Controller 30 is communicatively coupled to scanner unit 14, print engine 16, sheet feed mechanism 18, fax unit 20, automatic document feeder 22, user interface 24, and wireless communication unit 28 via communication links 34, 36, 38, 39, 40, 41, and 42, respectively. Controller 30 executes program instructions to operate various functions of imaging apparatus 10, and includes a scanner/printer driver to facilitate communication with scanner unit 14 and print engine 16, such as by providing control commands and facilitating appropriate data formats.

Scanner unit 14 may be, for example, a bed type scanner with a movable scan bar, a scanner having a stationary scan bar, wherein a document is scanned by moving the document past the activated scan bar, or a combination of both. Scanner unit 14, as a bed type scanner, may include for example, a document glass to support a target document to be scanned, with the moveable scan bar transported in a reciprocating manner under the scan glass by a scan bar transport mechanism.

Print engine 16 is configured to form an image 44 on a sheet of media 46, such as paper, transparency, etc. Print engine 16 may be, for example, an electrophotographic (e.g., laser) printing apparatus configured to form a latent image on an intermediate transfer medium, which in turn is transferred to the sheet of media 46 to form image 44 on the sheet of media 46. As another example, print engine 16 may be an ink jet print engine as more fully described below that directly prints by ejecting ink onto the sheet of media 46 to form image 44.

Sheet feed mechanism 18 is configured with hardware and electronic circuitry to feed the sheet of media 46 to and through print engine 16 during a printing operation. Sheet feed mechanism 18 may include, for example, a sheet picking device, sheet feed rollers, and associated drive train, as is known in the art. In some embodiments, sheet feed mechanism 18 may be configured to facilitate either or both of simplex or duplex printing.

Fax unit 20 is used in conjunction with scanner unit 14 and automatic document feeder 22, and is configured with electronic circuitry and/or firmware to process, format, and transmit image data received from scanner unit 14 during a fax operation, as is known in the art.

Automatic document feeder 22 is configured with hardware and electronic circuitry to automatically feed a target document to scanner unit 14, such as during a scanning operation, a copying operation, or a faxing operation. Automatic document feeder 22 may include, for example, a sheet picking device, sheet feed rollers, and associated drive train, as is known in the art.

Wireless communication unit 28 facilitates wireless communications for imaging apparatus 10, and may include, for example, electrical circuits and/or firmware to facilitate wireless communication using one or more wireless communications protocols, e.g., IEEE 802.xx, Bluetooth, WIFI, etc.

FIG. 2 shows an embodiment print engine 16 configured as an ink jet print engine. In the present embodiment, print engine 16 may include, for example, a main frame 50, a guide rod 52, a reciprocating printhead carrier 54, a drive motor 56, a drive belt 58, and a carrier position encoder 60. Carrier position encoder 60 includes a linear encoder strip 62 and an encoder sensor 64. Printhead carrier 54 is slidably coupled to guide rod 52. Drive belt 58 is connected to printhead carrier 54, and is driven by drive motor 56 operating under the control of controller 30.

Guide rod 52 is mounted to and suspended by main frame 50. Guide rod 52 extends lengthwise in a direction of extension along an axis 52-1 and defines a bidirectional main scan path 66, including direction 66-1 and direction 66-2. Sheet feed mechanism 18 (see FIG. 1) feeds the sheet of media 46 in an indexed manner in a sheet feed direction 68, which is perpendicular to bidirectional main scan path 66 of printhead carrier 54.

During a printing operation, guide rod 52 guides printhead carrier 54 back and forth along bidirectional main scan path 66, with drive motor 56 and drive belt 58 providing the driving force to move printhead carrier 54. Encoder sensor 64 of carrier position encoder 60 is communicatively coupled to controller 30, and reads linear encoder strip 62 as printhead carrier 54 is moved so as to provide carrier position data to controller 30 corresponding to a relative linear position of printhead carrier 54 along bidirectional main scan path 66.

Printhead carrier 54 is mechanically and electrically configured to mount and carry at least one printhead 70. Each printhead 70 is in fluid communication with at least one ink tank 72. In one embodiment, for example, printhead 70 and ink tank 72 and may be formed as an integral printhead cartridge, so as to be replaceable as a non-separable unit. In another embodiment, printhead 70 and ink tank 72 may be designed to be separable, so as to be individually replaceable, with printhead 70 being semi-permanently mounted to printhead carrier 54 (i.e., usable with multiple replaceable ink tanks 72), and with each ink tank 72 being replaceably coupled to printhead carrier 54 and printhead 70. In either embodiment, during a printing operation printhead carrier 54 transports printhead 70 in a reciprocating manner over an image surface of the sheet of media 46. Based on print commands provided by controller 30, printhead 70 selectively ejects ink to form image 44 on the sheet of media 46.

In accordance with an aspect of the present invention, a controller 30 executes program instructions to operate print engine 16 during a printing operation in a selected one of a plurality of print operation modes, including an environment friendly “Green Mode”. The print operation mode selection may be made, for example, based on inputs received from user interface 24, or the selection may be associated with commands or data received from an external device.

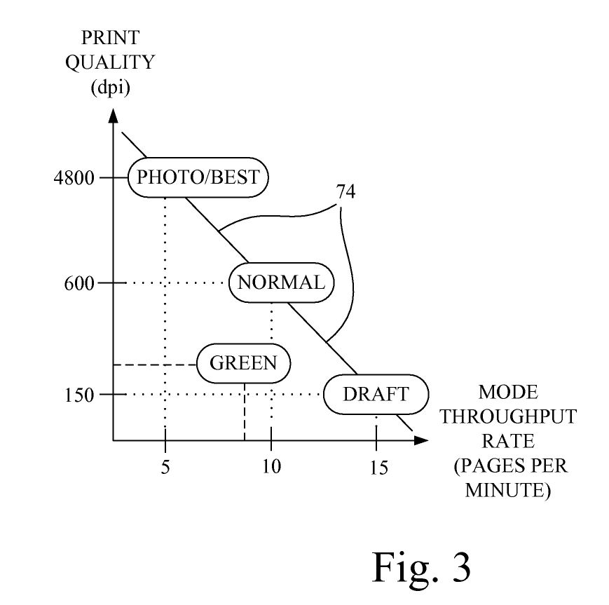

FIG. 3 is a graph illustrating by example the Green Mode, in relation to a continuum 74 of traditional printing modes: e.g., Best (Photo) Mode, Normal Mode, and Draft Mode. Continuum 74 represents the plurality of traditional printing modes, with continuum 74 being defined in terms of print quality versus mode throughput rate, wherein a decrease in print quality corresponds to an increase in mode throughput rate. In accordance with an aspect of the present invention, the Green Mode is located outside, i.e., off of, the continuum.

In an embodiment of the present invention, the print operation modes include, for example, the Best Mode, the Normal Mode, the Draft Mode and the Green Mode. The Best Mode has a first print quality and a first mode throughput rate. The Normal Mode has a second print quality lower than the first print quality and a second mode throughput rate higher than the first mode throughput rate. The Draft Mode has a third print quality lower than said second print quality and a third mode throughput rate higher than the second mode throughput rate. The Green Mode has a fourth print quality lower than the second print quality of the Normal Mode, and further may be higher than the third print quality of the Draft Mode, and has a fourth mode throughput rate lower than the third mode throughput rate of the Draft Mode, resulting in an energy consumption less than any of the Best Mode, the Normal Mode and the Draft Mode.

As used herein, the term “mode throughput rate” is the rate at which a page is processed through print engine 16 for a particular mode. This is in contrast to, for example, a maximum throughput rate of which imaging apparatus 10 may be capable. The mode throughput rate may be expressed, for example, as pages per minute. The term “pages per minute” refers to the rate at which a sheet of media, e.g., the sheet of media 46, having a predefined print coverage amount is completely processed through print engine 16 as transported by sheet feed mechanism 18. The predefined print coverage may be, for example, 60 percent print coverage over the printing area of the sheet of media.

Also, as used herein print quality may be expressed in terms of image density, e.g., in dots per inch (dpi) or percent coverage. For simplicity, and ease of discussion, image density will be considered in one dimension, e.g., horizontally along a scan line, although those skilled in the art will recognize that a vertical image density, i.e., perpendicular to the horizontal image density, may be varied instead of, or in addition to, the horizontal image density in the Green Mode.

In the example illustrated in FIG. 3, the first mode throughput rate associated with the Best Mode may be 5 pages per minute; the second mode throughput rate associated with the Normal Mode may be 10 pages per minute; the third mode throughput rate associated with the Draft Mode may be 15 pages per minute; and the fourth mode throughput rate associated with the Green Mode may be 9 pages per minute. The exact rate for the fourth mode throughput rate associated with the Green Mode may be determined empirically to provide the best energy consumption reduction at the fourth print quality associated with the Green Mode.

When operating in the Green Mode, the fourth mode throughput rate may result in a reduction of the energy consumption at least in part by slowing a rate at which each indexed move is performed by sheet feed mechanism 18, relative to that at which each indexed move is performed at the third mode throughput rate of the Draft Mode.

As an alternative, or in addition, to slowing a rate at which each indexed move is performed by sheet feed mechanism 18, when operating in the Green Mode, the fourth mode throughput rate may result in a reduction of the energy consumption at least in part by a reduction of a speed of movement of printhead carrier 54 along the bidirectional main scan path 66 relative to a speed that printhead carrier 54 travels along bidirectional main scan path 66 at the third mode throughput rate of the Draft Mode.

Referring again to FIG. 3, the first print quality associated with the Best Mode may be 4800 dpi (dots per inch); the second print quality associated with the Normal Mode may be 600 dpi; the third print quality rate associated with the Draft Mode may be 150 dpi; and the fourth print quality associated with the Green Mode may be 200 dpi. The print quality for the fourth print quality associated with the Green Mode may be determined empirically to provide the best energy consumption reduction at the fourth mode throughput rate associated with the Green Mode.

Thus, the fourth print quality of the Green Mode being lower than the second print quality of the Normal Mode may be achieved by a reduction in an image density of image 44 that is printed on the sheet of media 46. Alternatively, or in addition, to reducing image density, the fourth print quality of the Green Mode being lower than the second print quality of the Normal Mode may be achieved by a reduction in a size, i.e., footprint, of image 44 that is printed on the sheet of media 46.

Thus, the invention described above provides a printing mode, i.e., the “Green Mode”, which is outside of the typical continuum of traditional printing modes: e.g., Draft Mode, Normal Mode, and Best/Photo Mode.

In addition to the basic Green Mode described above, an enhanced Green Mode may be achieved by providing supplemental energy saving features. These supplemental energy saving features may be made to be selectable from user interface 24, e.g., from a Green Mode selection menu displayed on display 25, or may be made to be automatically engaged when the Green Mode is selected. More particularly, imaging apparatus 10 may include a plurality of selectable hardware functions, e.g., a scanning function facilitated by scanner unit 14 and automatic document feeder 22; a printing function facilitated by print engine 16 and sheet feed mechanism 18; a fax function facilitated by fax unit 20, scanner unit 14 and automatic document feeder 22; a wireless communication function facilitated by wireless communication unit 28, etc.

In accordance with this aspect of the present invention, controller 30 executes program instructions to put non-essential hardware functions ancillary to a selected hardware function into one of an OFF state and a reduced power consumption state (e.g., a standby mode) to supplement a reduction in the energy consumption provided by the basic Green Mode. For example, assume that the Green Mode is selected, and only the printing function (e.g., as the selected hardware function) is desired. Accordingly, it is not necessary from a power standpoint to maintain the availability of scanner unit 14, automatic document feeder 22, fax unit 20, or wireless communication unit 28 (in the present example, i.e., the non-essential hardware functions of the scanning function, fax function and wireless function) in an active power consuming state, since they are not used in the selected printing function. Accordingly, one or more, or all, of the non-essential hardware functions may be placed in an OFF state or a reduced power consumption state.

In embodiments wherein controller 30 includes at least one application specific integrated circuit having an operational clock rate, it is contemplated that further energy savings may be achieved during operation in the Green Mode by reducing the operational clock rate of the ASIC from that of a normal clock rate associated with the typical continuum of traditional printing modes.

Further, to aid in the reduction of use of materials during printing, when the Green Mode is selected, controller 30 may execute program instructions to selectively or automatically operate sheet feed mechanism 18 in a duplex mode when performing the printing function so as to conserve paper.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An imaging apparatus, comprising:
a print engine for printing an image on a sheet of media;
a sheet feed mechanism configured to feed said sheet of media through said print engine; and
a controller communicatively coupled to said sheet feed mechanism and said print engine to operate said sheet feed mechanism and said print engine in a selected one of a plurality of operation modes, said plurality of operation modes including:
a continuum representing a plurality of traditional printing modes, said continuum being defined in terms of print quality versus mode throughput rate wherein a decrease in print quality corresponds to an increase in mode throughput rate; and
a Green Mode located outside said continuum.

2. The imaging apparatus of claim 1, wherein said plurality of traditional print modes includes:
a Best Mode having a first print quality and a first mode throughput rate;
a Normal Mode having a second print quality lower than said first print quality and a second mode throughput rate higher than said first mode throughput rate; and
a Draft Mode having a third print quality lower than said second print quality and a third mode throughput rate higher than said second mode throughput rate.

3. The imaging apparatus of claim 2, wherein said Green Mode has a fourth print quality lower than said second print quality and a fourth mode throughput rate lower than said third mode throughput rate resulting in an energy consumption less than any of said Best Mode, said Normal Mode and said Draft Mode.

4. The imaging apparatus of claim 3, wherein said sheet feeding mechanism feeds said sheet of media in indexed moves in a sheet feed direction, and wherein when operating in said Green Mode, said fourth mode throughput rate results in a reduction of said energy consumption at least in part by slowing a rate at which each indexed move is performed relative to that at which each indexed move is performed at said third mode throughput rate of said Draft Mode.

5. The imaging apparatus of claim 3, wherein said print engine includes a printhead carrier that moves along a bidirectional scan path, and wherein when operating in said Green Mode, said fourth mode throughput rate results in a reduction of said energy consumption at least in part by a reduction of a speed of movement of said printhead carrier along said bidirectional scan path relative to a speed that said printhead carrier travels along said bidirectional scan path at said third mode throughput rate of said Draft Mode.

6. The imaging apparatus of claim 3, wherein said fourth print quality of said Green Mode being lower than said second print quality of said Normal Mode is achieved at least in part by a reduction in an image density.

7. The imaging apparatus of claim 3, wherein said fourth print quality of said Green Mode being lower than said second print quality of said Normal Mode is achieved at least in part by a reduction in a size of said image that is printed on said sheet of media.

8. The imaging apparatus of claim 1, further comprising a plurality of selectable hardware functions, said controller executing program instructions to put non-essential hardware functions ancillary to a selected hardware function into one of an OFF state and a reduced power consumption state to supplement a reduction in said energy consumption.

9. The imaging apparatus of claim 8, wherein said plurality of selectable hardware functions include a printing function facilitated by said print engine, and at least one other of a scanning function facilitated by a scanner unit, a fax function facilitated by a facsimile unit, a wireless communication function facilitated by a wireless communication unit, and an automatic document feeder associated with said scanner unit and said fax unit.

10. The imaging apparatus of claim 1, wherein said controller includes at least one application specific integrated circuit having an operational clock rate, wherein during operation in said Green Mode, said operational clock rate is reduced from a normal clock rate.

11. The imaging apparatus of claim 1, wherein when said Green Mode is selected, said controller executes program instructions to automatically operate said sheet feed mechanism in a duplex mode for printing to conserve paper.

12. An imaging apparatus, comprising:
a print engine for printing an image on a sheet of media;
a sheet feed mechanism configured to feed said sheet of media through said print engine; and
a controller communicatively coupled to said sheet feed mechanism and said print engine to operate said sheet feed mechanism and said print engine in a selected one of a plurality of operation modes, said operation modes including:
a Best Mode having a first print quality and a first mode throughput rate;
a Normal Mode having a second print quality lower than said first print quality and a second mode throughput rate higher than said first mode throughput rate;
a Draft Mode having a third print quality lower than said second print quality and a third mode throughput rate higher than said second mode throughput rate; and
a Green Mode having a fourth print quality lower than said second print quality and a fourth mode throughput rate lower than said third mode throughput rate resulting in an energy consumption less than any of said Best Mode, said Normal Mode and said Draft Mode.

13. The imaging apparatus of claim 12, wherein said sheet feeding mechanism feeds said sheet of media in indexed moves in a sheet feed direction, and wherein when operating in said Green Mode, said fourth mode throughput rate results in a reduction of said energy consumption at least in part by slowing a rate at which each indexed move is performed relative to that at which each indexed move is performed at said third mode throughput rate of said Draft Mode.

14. The imaging apparatus of claim 12, wherein when operating in said Green Mode, said fourth mode throughput rate results in a reduction of said energy consumption at least in part by a reduction of a speed of movement of said printhead carrier along said bidirectional scan path relative to a speed that said printhead carrier travels along said bidirectional scan path at said third mode throughput rate of said Draft Mode.

15. The imaging apparatus of claim 12, wherein said fourth print quality of said Green Mode being lower than said second print quality of said Normal Mode is achieved at least in part by a reduction in an image density.

16. The imaging apparatus of claim 12, wherein said fourth print quality of said Green Mode being lower than said second print quality of said Normal Mode is achieved at least in part by a reduction in a size of said image that is printed on said sheet of media.

17. The imaging apparatus of claim 12, further comprising a plurality of selectable hardware functions, said controller executing program instructions to put non-essential hardware functions ancillary to a selected hardware function into one of an OFF state and a reduced power consumption state to supplement a reduction in said energy consumption.

18. The imaging apparatus of claim 17, wherein said plurality of selectable hardware functions include a printing function facilitated by said print engine, and at least one other of a scanning function facilitated by a scanner unit, a fax function facilitated by a facsimile unit, a wireless communication function facilitated by a wireless communication unit, and an automatic document feeder associated with said scanner unit and said fax unit.

19. The imaging apparatus of claim 12, wherein said controller includes at least one application specific integrated circuit having an operational clock rate, wherein during operation in said Green Mode, said operational clock rate is reduced from a normal clock rate.

20. The imaging apparatus of claim 12, wherein when said Green Mode is selected, said controller executes program instructions to automatically operate said sheet feed mechanism in a duplex mode for printing to conserve paper.
